(19) United States
(12) Patent Application Publication
(10) Pub. No.: US 2003/0200105 A1
(43) Pub. Date: Oct. 23, 2003

(54) Method and system for hosting legacy data

(76) Inventors: George R. Borden, IV, Portland, OR (US); Gary Feather, Camas, WA (US); Benjamin J. Joy, Portland, OR (US)

Correspondence Address: Kevin L. Russell, Suite 1600, 601 SW Second Ave.,, Portland, OR, 97204-3157, US

(21) Appl. No.: 10/126,865

(22) Filed: Apr. 19, 2002

(51) Int. Cl. G06F 17/60

(52) U.S. Cl. 705/1

(57) ABSTRACT

To attract potential customers to a web site, the site offers inexpensive conversion and storage of legacy data.

### CROSS-REFERENCE TO RELATED APPLICATIONS

Not applicable.

### BACKGROUND OF THE INVENTION

The present invention relates to electronic commerce and, more particularly, to a method of attracting potential consumers to a merchant's business via an interactive data processing network.

The rapid increase in the popularity of the Internet and the World Wide Web (the, “web”) has attracted businesses to establish web sites for online businesses selling goods and services. One problem common to all merchants, including online merchants, is attracting potential customers to the business so that the potential customer can initially experience the merchant's goods or services and provide the merchant with an opportunity to develop a relationship with the customer. Typically, businesses attempt to attract customers through television, newspaper, and web advertising. However, these methods can be expensive, consume considerable human resources, and are often difficult to evaluate for effectiveness. Attracting potential customers is a particular problem for online businesses because an online business typically utilizes a new business method confronting the potential customer with substantial barriers to adoption and to the likelihood that the potential customer's substantial investment in the legacy or result of performing an activity in a traditional manner must be forgone to adopt the new method. For example, to convert from film photography to digital photography, a consumer must typically obtain a new camera, a personal computer (PC), image capture and editing software, and a photo quality printer. Further, the consumer must decide whether to invest in equipment to convert a substantial legacy of data in the form of film photos and video to digitally formatted data or to leave behind the legacy data represented by the film-based images.

What is desired, therefore, is a data processing method useful in attracting potential customers to a business and enticing those potential customers to sample the goods and service of an online business.

### BRIEF DESCRIPTION OF THE DRAWINGS

FIG. 1 is a block diagram of a data processing system facilitating user interaction with a merchant web site.

FIG. 2 is a pictorial representation of an exemplary home page for a merchant web site.

FIG. 3 is a pictorial representation of an exemplary customer registration page for a merchant web site.

FIG. 4 is a pictorial representation of an exemplary photo hosting services options page for a merchant web site.

FIG. 5 is a pictorial representation of an exemplary photo hosting page for a merchant web site.

### DETAILED DESCRIPTION OF THE INVENTION

A problem facing all businesses, including online businesses, is attracting potential customers so that the potential customer can experience the goods or services offered by the business affording the business an opportunity to develop an enduring relationship with the customer. Online businesses are particularly affected by the problem because of the substantial barriers to a potential customer's initial interest and contact with the business. For example, initial contact with any online business requires that the potential customer have access to the worldwide web (the “web”) which typically means an investment in a personal computer or other Internet appliance and an agreement with a service provider facilitating access to the Internet. In addition, many of the services offered by online businesses may require that customers make additional investments in equipment and training that would not be required in dealing with a traditional, “bricks and mortar” competitor to the online business. For example, for a consumer desiring to convert from film print and slide photography to sharing digital images over the Internet must, at least, acquire a digital camera, an image capture and editing computer program, and a reasonably high speed network connection. However, even with this investment, the consumer must consider leaving behind a substantial collection of film prints and video or investing in a scanner or a scanning service to convert the film-based legacy collection to non-legacy (digital) data for electronic storage. The cost of the equipment and software required to enter the digital photography field and the cost of converting or leaving behind a film-based collection of prints and video presents a substantial barrier to adoption of digital photography and, therefore, a substantial impediment to the growth of businesses offering services related to digital imaging. The present inventors concluded that a business could generate initial interest of consumers by reducing the barriers to adoption of a new business method and, more specifically, by offering to convert data from a legacy format to a non-legacy format and to store the converted data for a potential customer for free or at a nominal cost.

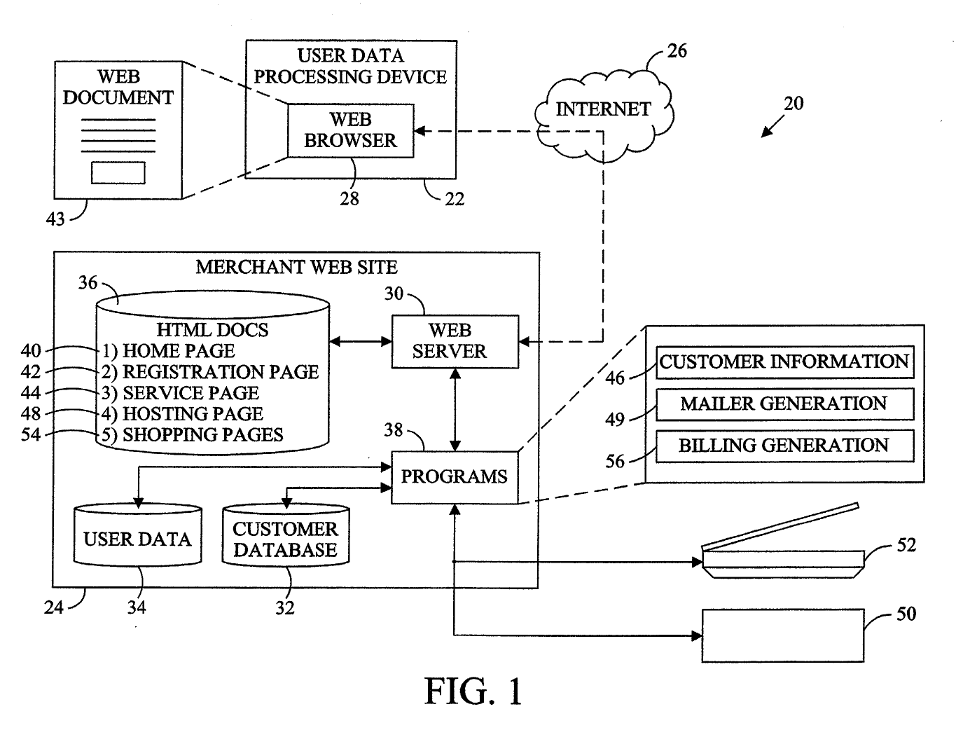

FIG. 1 illustrates the general architecture of an on-line business operating in accordance with the present method. The business comprises generally a data processing system 20 that includes a customer data processing device or computer 22 and a merchant web site 24. The merchant web site comprises, generally, a computer system serving informational content over a data processing network using the standard protocols of the World Wide Web (the “web”). The customers' computer 22 and the merchant web site 24 are linked by the Internet 26, a collection of interconnected data processing networks that are linked together by a set of standard protocols (such as TCP/IP (Transmission Control Protocol/Internet Protocol) and HTTP (HyperText Transport Protocol)) to form a global, distributed communication network. The customer's data processing device or computer 22 may be any type of data processing device that permits a user (the “customer”) to interactively browse web sites with a web browser program 28. For example, the customers' computer may be a personal computer (PC) that runs the Windows operating system or it may be an Internet appliance.

The merchant web site 24 provides a variety of functionality permitting customers to obtain products and services offered by the merchant by interaction between the customer's computer 22 and the merchant's web server 30. The potential customer accesses the merchant's web site 24 using a standard web browser program 28, such as Microsoft Internet Explorer or Netscape Navigator, which uses HTTP to communicate with the web server 30 at the merchant's web site 24. HTTP is the standard client-server protocol used on the web for exchanging information (such as, HTML (HyperText Markup Language) documents and client requests for those documents) between a web browser 28 and a web server 30.

The merchant web site 24 comprises generally a web server 30 for communicating information over the web, but may also include several other data processing devices performing specific tasks and processes related to the web site. In addition, the exemplary merchant web site includes a customer data base 32 including information supplied by and related to individual users of the merchant web site 24, a data base of user supplied data which the merchant web site hosts or stores for users 34, a data base of HTML documents 36 for transmission to and display on the customer's data processing device 22, and several programs 38 that perform various data processing functions related to the business conducted at the merchant's web site 24. Any of the data bases and programs comprising the web site may be stored on and executed by the web server 30 or by another data processing device networked with the web server.

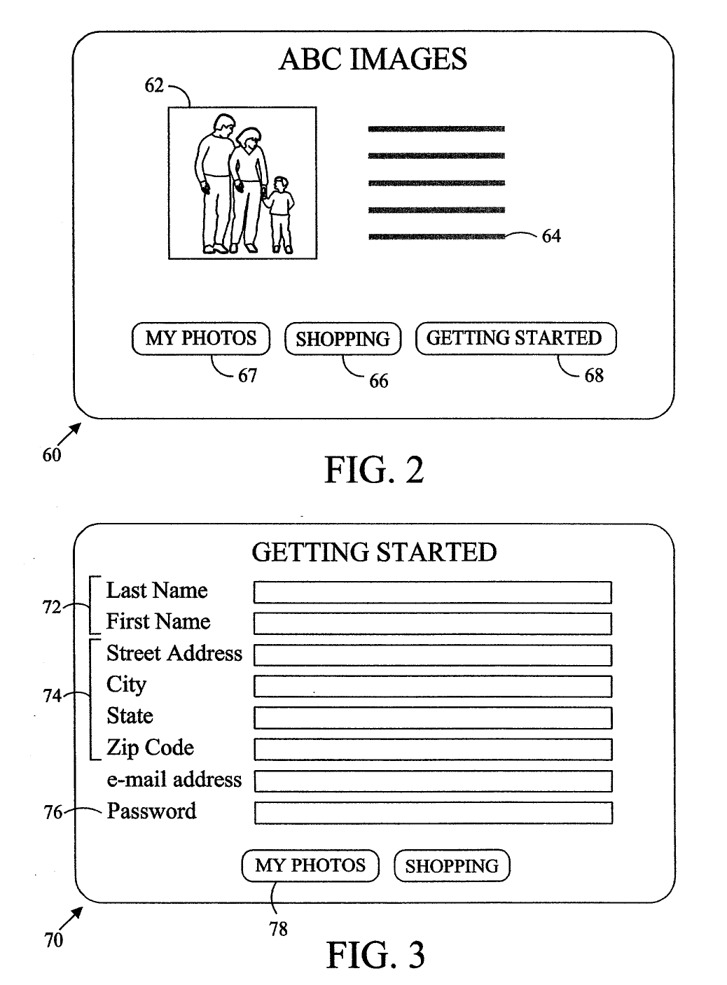

The user's data processing device 22 communicates with the merchant's web site 24 via a web browser program 28. When the web browser 28 contacts the merchant's web site 24, the web server 30 initially, selects a home page document 40 from the HTML document data base 36 and transmits the document to the user's data processing device where the home page is displayed as a web document 43. Referring to FIG. 2, an exemplary homepage 60 is a HTML document that may include images 62, video, sounds, and text 64 and typically includes a plurality of hyperlinks (“links”) 66 to other documents. Typically, a link 66 is displayed as a highlighted word or symbol that can be selected with a computer mouse. Selecting a link causes the web server 30 to obtain the linked document from the address in the provided by the hyperlink and transmit the document to the user's data processing device 22. A typical homepage 60 includes general information about the merchant and the goods and services that the merchant offers and links to pages displaying additional information about specific topics that may be of interest to potential site users.

Since initially the merchant will not have sufficient information related to the potential customer to engage in a business transaction, the exemplary homepage 60 includes a link 68 that cause the web server 30 to transmit a registration page 44 to the user's data processing device 22. Referring to FIG. 3, an exemplary registration page 70 requests that the customer provide identifying data, such as name 72 (indicated by a bracket) and address 74 (indicated by a bracket) which the merchant will use for shipping and billing when the customer orders goods or services. The exemplary registration page also facilitates selection of a password 76 by the user, permitting the user to self identify to the merchant web site 24 during future visits. When the user has completed the registration page 70, the user's data processing device 22 returns the data to the merchant's web server 30. At the merchant's web site 24 a programs 46 parses the customer's information from the response and stores it for future reference in the customer data base 32 on one of the web site's storage devices.

The exemplary merchant web site 24 represents an exemplary online business providing goods and services related to digital photography. One or more documents stored in the HTML document data base 36 may relate to the sales of goods or rendering of services by the business 54 and the programs 38 typically include a program that generates a bill 56 for transmission to customers purchasing the goods or services offered by the business. For example, the business may generate revenue by charging a fee for duplicating images or video, creating digital video disks containing a user's images or video, or selling image editing software. Hosting or storing digital photographs and video on storage devices connected to the merchant's web server 24 is one of the services offered by the business. Customers can upload digital photos and video over the Internet 26 to the web server 30 at the merchant's web site 24 where the data is stored for the customer in the user data base 34 on storage devices operated by the data processing devices at the web site. A customer can then download the customer's own data to view or print his or her photos locally or e-mail the digital photos or video to others. In addition, the user may add metadata providing information about the stored images, such as title, subject, or date, to the user data 34 by interaction of the user's data processing device 22 and the web server 30.

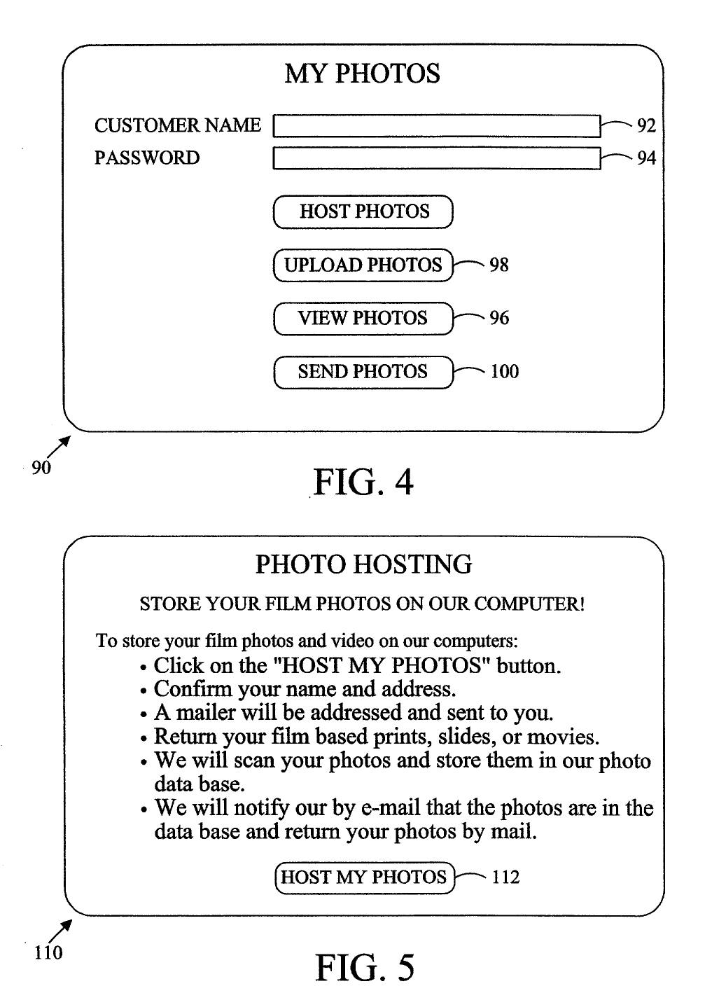

To engage the business' hosting services, the customer can select a link to “MY PHOTOS” 67 in the homepage document 60 or the “MY PHOTOS” link 78 on the registration page 70. In response, the web server 30 transmits a hosting services page 44 from the HTML documents data base 36 to the user's data processing device 22. Referring to FIG. 4, an exemplary hosting services page 90 requires a user log in (name 92 and password 94) corresponding to the customer's name and password stored in the customer data base 32 to gain access to the customer's data stored in the data base of user data 34. Once the user has correctly logged in, the user can select several options, including viewing the photos 96, uploading digital photos from the user's data processing device for storage in the user data base 98, and sending photos 100, typically as e-mail attachments, to other the data processing devices.

To reduce a barrier to adopting digital photography and to attract potential customers to the web site of the exemplary online business, the business offers hosting services for legacy data, a user's film-based photo and video collection, which is converted to non-legacy (digital) data, free of charge or for a nominal fee. When the customer logs onto the photo services page 90, a link 102 directs the customer to a page related to hosting services 48. Referring to FIG. 5, an exemplary hosting services page 110 explains the process for hosting film-based photos and video. When the customer selects a button 112 indicating a desire to engage the hosting services at the merchant web site 24, a mailer generation program 49 obtains the customer's name and address from the customer data base 32 and requests that the customer confirm the data. When the customer's name and address are confirmed, a program 49 generates and prints 50 a mailer (such as a mailing envelope or mailing label) to be mailed or e-mailed, if appropriate) to the user with instructions for returning the film-based photos and video. The customer returns the film-based photos and video, to the address on the mailer where the images in the photos and video are scanned 52 converting the legacy data to digital data that is stored in the user data base 34. The customer is notified, typically by e-mail, that the legacy data have been included in the user data 34 and are available for viewing, downloading or transmission to others. The original photos are returned to the customer by mail.

Converting film-based photos and video or other legacy data to non-legacy (digital) format data and hosting the digital data at the merchant's web site 24, provides the customer with many of the benefits of digital photography without incurring a substantial part of the cost of adopting the new photographic method while facilitating the continued enjoyment of an existing collection of film photos and video. On the other hand, customers will be attracted to the merchant's web site by the offer of free or nominal cost hosting providing the merchant with a potential customer base and necessary customer information that will permit the merchant to contact the customer and offer goods and service for a fee.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

The invention claimed is:

1. A method of operating a web site comprising a web server, said method comprising the steps of:
(a) facilitating interaction between said web server and a data processing device operated by a user;
(b) collecting a user datum in response to an interaction between said web server and said data processing device operated by said user;
(c) permitting said user to select a data hosting service by an interaction between said data processing device operated by said user and said web server;
(d) in response to said selection of said data hosting service, causing said web server to generate a mailer utilizing said user datum;
(e) transmitting said mailer to said user for use by said user in transmitting a legacy datum;
(f) converting user supplied legacy data to non-legacy format data;
(g) storing said non-legacy format data; and
(h) facilitating said user's access to said stored data originating from said user.

2. The method of claim 1 wherein the steps of converting and storage of said user supplied legacy data is provided without substantial charge to said user.

3. The method of claim 1 further comprising the step of permitting a user to store user supplied data at said web site in said non-legacy format by interaction of said data processing device operated by said user and said web server.

4. The method of claim 1 further comprising the steps of:
(a) permitting a user to store user supplied data at said merchant web site in said non-legacy format by interaction of said user's data processing device and said merchant web site;
(b) calculating a fee for said storage of said user supplied data in response to storage of said data; and
(c) transmitting a bill for said fee to said user.

5. The method of claim 1 further comprising the step of facilitating addition of metadata to said stored data by interaction of said data processing device operated by said user and said web server.

6. A method of operating a web site comprising a web server, said method comprising the steps of:
(a) facilitating interaction between said web server and a data processing device operated by a user;
(b) collecting a user datum in response to an interaction between said web server and said data processing device operated by said user;
(c) permitting said user to select a data hosting service by an interaction between said data processing device operated by said user and said web server;
(d) in response to said selection of said data hosting service, causing said web server to generate a mailer utilizing said user datum;
(e) transmitting said mailer to said user for use by said user in transmitting a legacy datum;
(f) converting user supplied legacy data to non-legacy format data;
(g) storing said non-legacy format data; and
(h) facilitating said user's access to said stored data originating from said user; and
(i) facilitating addition of metadata to said stored data by interaction of said data processing device operated by said user and said web server.

7. A method of operating a network enabled service, said method comprising the steps of:
(a) facilitating interaction between said service and a data processing device operated by a user;
(b) collecting a user datum in response to an interaction between said service and said data processing device operated by said user;
(c) permitting said user to select a data hosting service by an interaction between said data processing device operated by said user and said service;
(d) in response to said selection of said data hosting service, causing said service to generate a mailer utilizing said user datum;
(e) transmitting said mailer to said user for use by said user in transmitting a legacy datum;
(f) converting user supplied legacy data to non-legacy format data;
(g) storing said non-legacy format data; and
(h) facilitating said user's access to said stored data originating from said user.

8. The method of claim 7 wherein the steps of converting and storage of said user supplied legacy data is provided without substantial charge to said user.

9. The method of claim 7 further comprising the step of permitting a user to store user supplied data at said service in said non-legacy format by interaction of said data processing device operated by said user and said service.

10. The method of claim 7 further comprising the steps of:
(a) permitting a user to store user supplied data at said service site in said non-legacy format by interaction of said user's data processing device and said service;
(b) calculating a fee for said storage of said user supplied data in response to storage of said data; and
(c) transmitting a bill for said fee to said user.

11. The method of claim 7 further comprising the step of facilitating addition of metadata to said stored data by interaction of said data processing device operated by said user and said service.
